(19) United States
(12) Patent Application Publication
(10) Pub. No.: US 2006/0248522 A1
(43) Pub. Date: Nov. 2, 2006

(54) Deploying agent software to managed computer systems

(75) Inventors: Anand Lakshminarayanan, Redmond, WA (US); Anandha K. Ganesan, Redmond, WA (US); Appireddy Kikkuru, Redmond, WA (US); Arun D. Raghavan, Seattle, WA (US); Baelson B. Duque, Redmond, WA (US); Travis A. Wright, Everett, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/107,541

(22) Filed: Apr. 15, 2005

(51) Int. Cl. G06F 7/00; G06F 9/445; G06F 17/00

(52) U.S. Cl. 717/174; 707/102

(57) ABSTRACT

In an operations management system comprising a central server managing a plurality of computer systems, the teachings herein provide automated methods performed by the central server for deploying and maintaining agent software to the managed computer systems. Various embodiments of the automated method include enabling a user to select target computer systems to which the agent software will be deployed, pre-qualifying the target computer systems to identify issues that may impact the deployment of the agent software, ensuring network connectivity from the target computer systems back to the central server, and simultaneously and asynchronously push-deploying the agent software to the each of the plurality of target computer systems. Articles of manufacture and program storage devices containing computer program code embodying the above method are also provided.

### TECHNICAL FIELD

This invention relates to managed computer systems, and to techniques for deploying and maintaining agent software on managed computer systems.

### BACKGROUND

Operations management systems automate management of large numbers of servers or other computer systems from a central server. However, installing or upgrading software on the managed computer systems can be a daunting task, especially when managing hundreds or thousands of managed systems. There is an ongoing need to improve existing techniques for automating deployment and maintenance of software agents installed and running on managed computer systems.

### SUMMARY

An operations management system for deploying and maintaining agent software on managed computer systems is described. The operations management system enables a user to select target computer systems to which the agent software will be deployed. The system pre-qualifies the target computer systems to identify issues that may impact the deployment of the agent software, ensures network connectivity from the target computer systems back to the central server, and asynchronously push-deploys the agent software to the target computer systems in parallel.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 is a block diagram of an illustrative computing architecture that implements an operations management system.

FIG. 2 is a flow diagram illustrating a process for obtaining parameters governing how agent software is to be deployed onto managed computers.

FIG. 3 is a block diagram illustrating user interfaces provided by the installation wizard used in the installation process of FIG. 2.

FIG. 4 is a flowchart illustrating a process by which computer discovery rules are executed to select target computers for deployment.

FIG. 5 is a flowchart illustrating a process by which the agent software is installed on the target computers.

FIG. 6 is a flowchart illustrating a process by which agent software deployed on various managed computers can be upgraded remotely.

FIG. 7 is a flowchart illustrating a process by which agent software deployed on various managed computers can be patched remotely.

FIG. 8 is a flowchart illustrating a process by which agent software deployed on various managed computers can be remotely synchronized with a central computer.

FIG. 8A is a diagram of a user interface that supports the synchronization process shown in FIG. 8.

FIG. 9 is a flowchart illustrating a process by which agent software deployed on various managed computers can “self heal”.

FIG. 10 is a block diagram of an overall computing environment suitable for practicing the instant teachings.

### DETAILED DESCRIPTION

Computer Architecture

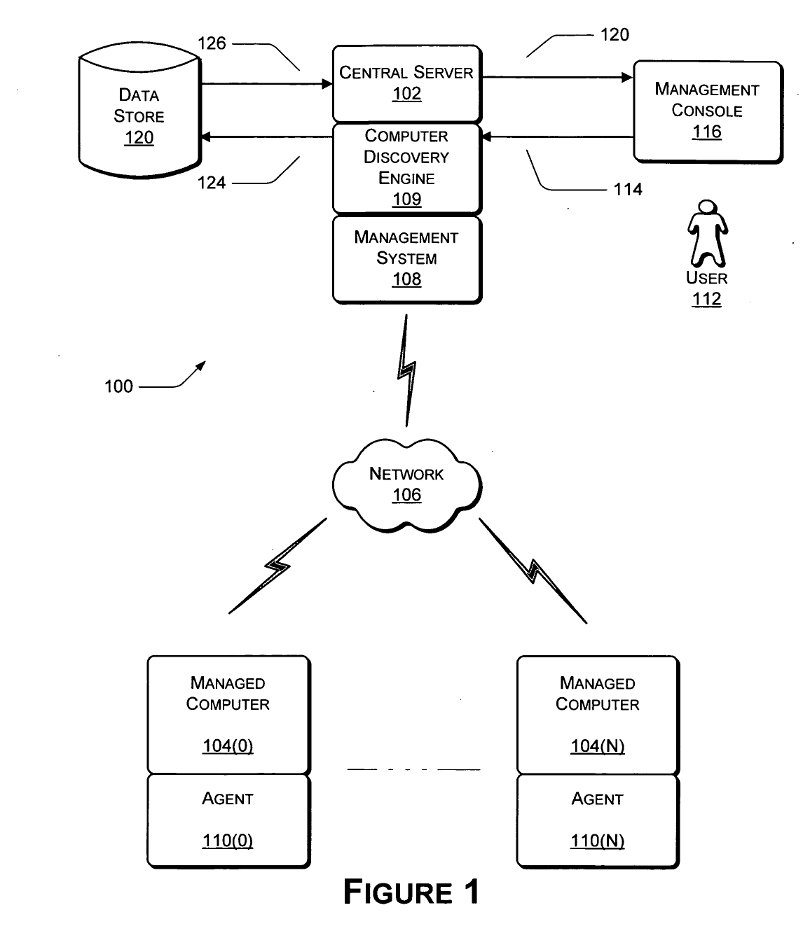

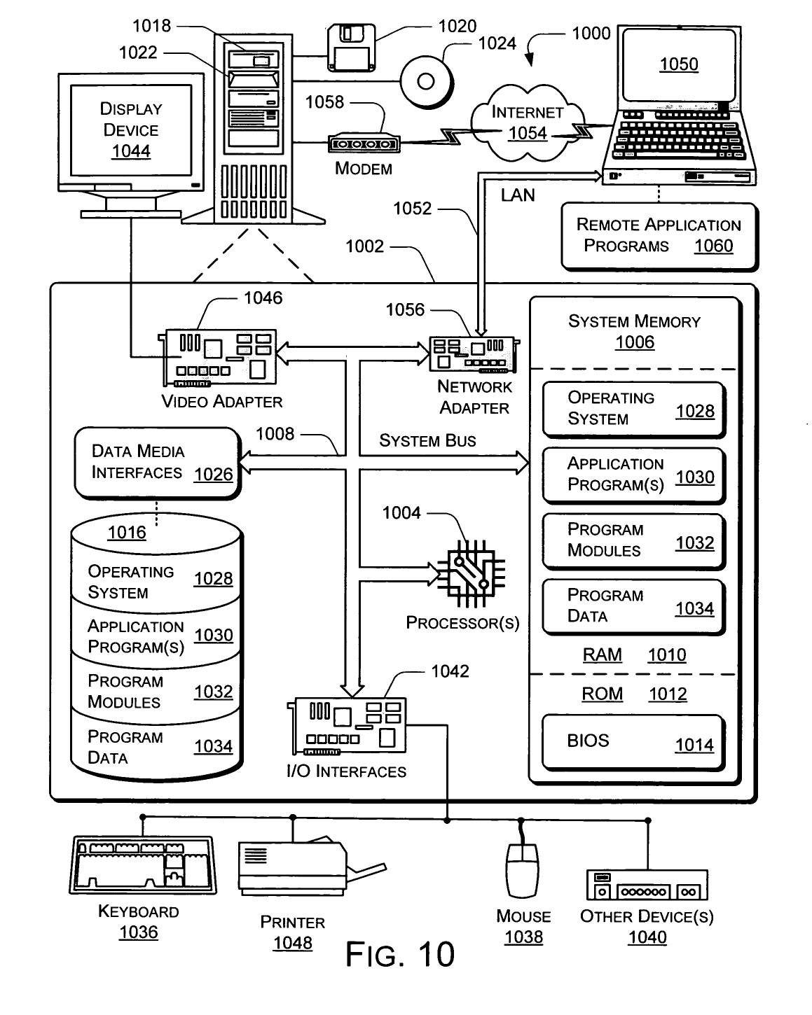

FIG. 1 illustrates exemplary computer architecture 100 having a central server 102 that is coupled to communicate with a plurality of managed computers 104(0) and 104(N) (collectively referred to by the reference sign 104). The central server 102 and the various managed computers 104 are connected via a suitable communications network 106. The central or management server 102 is a computer system from which an operations management system 108 is executed, and can include a computer discovery engine 109, which is discussed in further detail below. A managed computer 104 is any computer or server that is managed by or from the central server 102. The central server 102 and/or the managed computers 104 can be implemented using, for example, all or parts of the configuration shown in FIG. 10, which is discussed in more detail below.

The operations management system 108 automates the management of large numbers of managed computers 104 deployed within a given enterprise. A suitable example of such an operations management system 108 is the Microsoft Operations Manager, referred to hereinafter as the “MOM” system, which is available commercially from Microsoft Corporation of Redmond, Wash. Components of the operations management system 108 are installed both on the managed computers 104 and on the central server 102. On the managed computers 104, agent software 110(0) and 110(N) (referred to collectively as agent software 110) acts on behalf of the central server 102 and/or the operations management system 108 to implement rules or directives. In general, directives and rules specify how to operate the managed computers 104.

At the central server 102, a user 112 issues commands 114 via a management console 116, and also receives status updates and other information 120 from the central server 102 via the management console 114. A data store 122 receives computer discovery rules and other information 124 from the central server 102. The data store 122 also, on command, provides information 126 to the central server 102 that specifies how the managed computers 104 are to be configured.

When first installing the management system 108 on the architecture 100, or when adding additional managed computers 106 to architecture 100 where management systems 108 are already installed, the agents 110 may be deployed across hundreds or thousands of managed computers 104. At such scales of operation, customers demand fast, reliable methods for automatically deploying the agents 110 on the managed computers 104. While the agent deployment is automated as much as possible, certain aspects of the deployment may optionally provide for manual intervention or approval by the user 112 at various stages of the deployment process.

There are many challenges to remotely installing agents 110 from a central server 102 to hundreds or thousands of managed computers 104. Non-limiting examples of such challenges can include: restrictions imposed by firewalls protecting the managed computers 106, domain structures or other organization relationships among the central server 102 and the managed computers 106, trust relationships, permissions and other privilege schemes, service dependencies, observing minimum system requirements in terms of hardware/software, security, network speed/connectivity/configuration, compatibility issues with various operating system versions and chipset architectures, and the like. Additionally, several security-related considerations may become relevant, such as secure storage and transmission of credentials over a network, packet tampering during transmission, authentication (ensure that software intended for Computer X is actually installed on Computer X, not Computer Y impersonating Computer X), and authorization (ensure that the user 110 has the requisite permission to perform whatever task sought by the user 110).

To deploy the agents 110 successfully to the managed computers 104, the operations management system 108 anticipates, identifies, and pre-empts as many failures as possible. In addition, the operations management system 108 provides the users 112 with near-real-time detailed status on the deployment, alerts the users 112 as soon as possible when problems arises, provides knowledge and remedial tasks to help solve problems, and provide detailed log or other information to help the users 112 diagnose deployment issues.

After the agent software 110 is initially deployed, the operations management system 108 provides mechanisms to patch, upgrade, configure, and otherwise maintain the agent software 110 remotely from the central server 102. Further, if certain managed computers 104 are later removed from the domain of the operations management system 108, then the agent software 110 may be uninstalled from the managed computers 104, with possibly other software as well.

Various aspects of the teachings herein are discussed in more detail below, beginning with initial installation of the agents 108 on the managed computers 106, and continuing with post-installation maintenance, support, upgrades, and the like.

Initially Installing Agents on Managed Computers

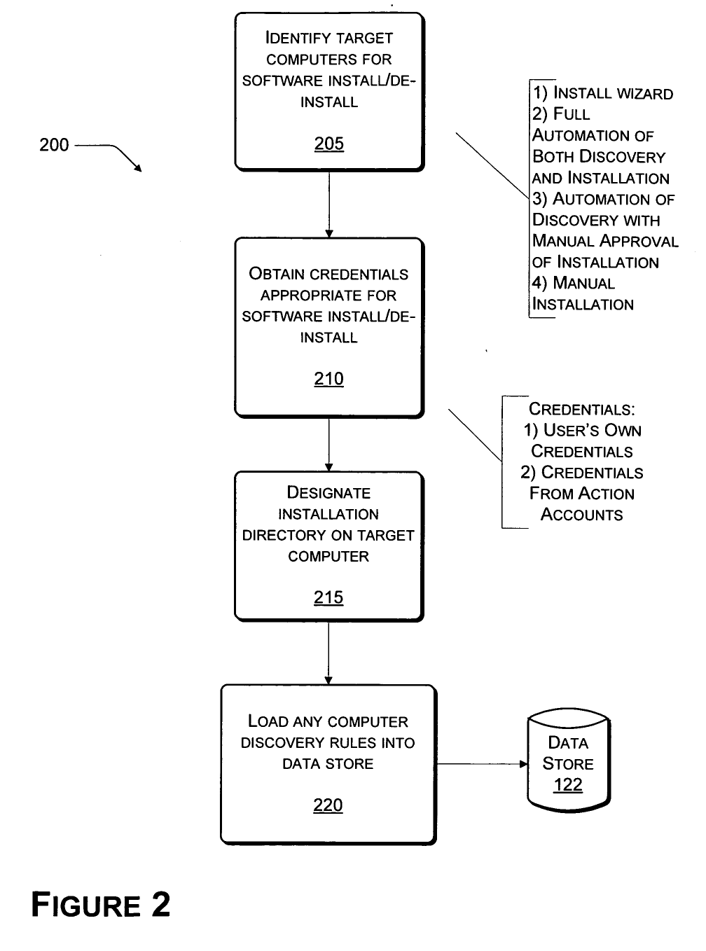

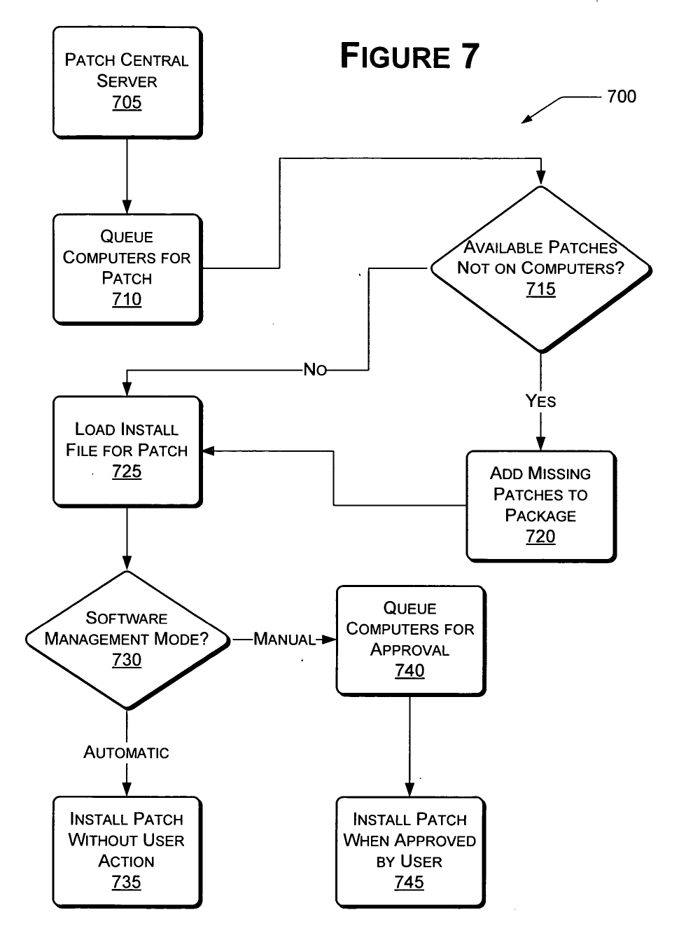

FIG. 2 shows a process 200 for initially installing the agent software 110 onto the managed computers 106. The process 200 is illustrated as a collection of blocks in a logical flow graph, which represent a sequence of operations that can be implemented in hardware, software, or a combination thereof. In the context of software, the blocks represent computer instructions that, when executed by one or more processors, perform the recited operations. For discussion purposes, the process 200 is described with reference to the architecture 100 and the computer system configurations shown in FIG. 7. It is noted that the process 200 may be implemented by other devices and architectures, and further noted that the process 200 (and other processes described herein) may be implemented in orders other than those illustrate and described herein.

When initially installing the agent software 110 onto the managed computers 104, one of the first steps in the process is to identify the managed computers 104 on which to install the agent software 110, i.e., the target computers 104. For convenience of discussion, a target computer 104 is any computer that is either currently a managed computer 104 or is in the process of becoming a managed computer 104. A target computer 104 may be, for example, a managed computer 104 that is being processed by a given execution of the installation or deployment techniques taught herein. Generally, any computer within the domain of the operations management system 108 may be characterized as a central server 102, a managed computer 104, or a target computer 104.

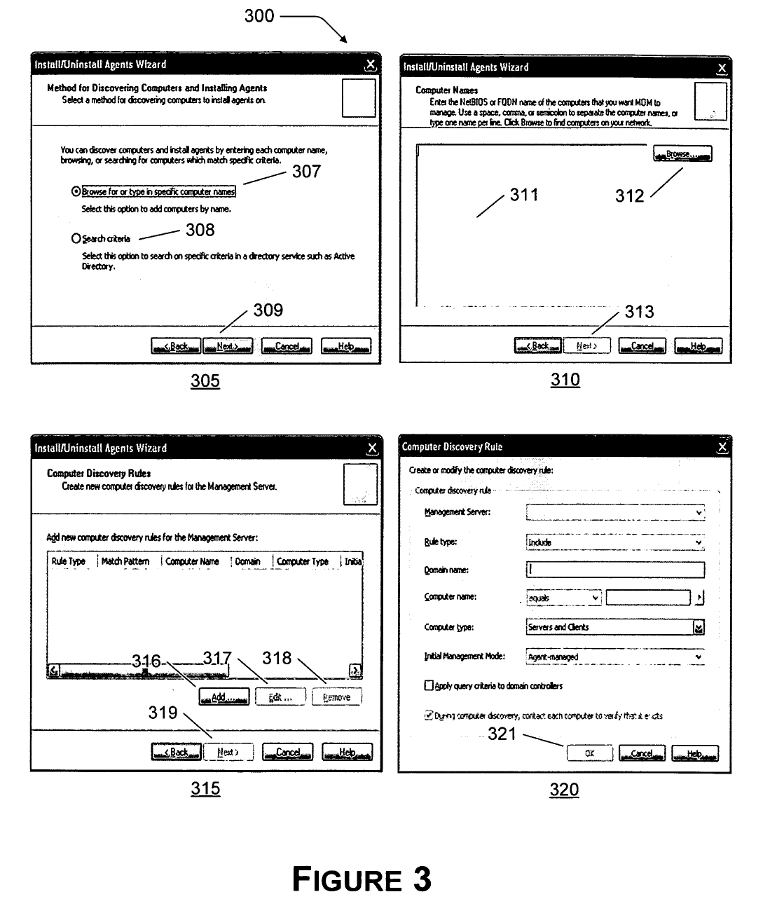

Turning to block 205 in FIG. 2, the process 200 enables the user 112 to identify or specify the target computers 106 on which to install the agent software 110 in several ways. First, the process 200 provides an automated, interactive installation wizard 300 (illustrated and discussed below in connection with FIG. 3) that can guide the user 112 through the process of locating managed/target computers 104, installing the agent software 110, and configuring the agent software 110. Second, the process 200 can fully automate both the discovery of target computers 104 and the subsequent installation of the agent software 110 on the discovered target computers 104. Third, the process 200 can fully automate the discovery of the target computers 104, but not install the agent software 110 onto the discovered target computers 104 until approved by the user 112. Finally, the process 200 can support manual installation of the agent software 110 onto any target computers 104 to which the agent software 110 cannot be deployed automatically.

A. Installation Wizard

FIG. 3 illustrates several graphical user interfaces (GUIs) provided by the installation wizard 300, which can enable the user 112 to locate target computers 104 in several different ways. These various user interfaces can include various icons, buttons, or fill-in fields that are responsive to input from the user 112 to initiate the processing described herein.

Block 305 represents a GUI that provides the user 112 with various options for specifying how the target computers 104 are to be discovered. The user 112 can activate area 307 to specify that the target computers 104 are be discovered by browsing through a directory or by entering their names. Alternatively, the user 112 can activate area 308 to specify that the target computers 104 are to be discovered by searching a directory listing of candidate target computers 104. In any event, when the user 112 has chosen which area to activate, the user 112 proceeds by activating the “Next” button 309. Respective buttons enable the user 112 to revisit a past selection (“Back”), seek help (“Help”), or cancel the process (“Cancel”).

Block 310 represents a GUI accessible to the user 112 by activating the area 307 in block 305. Block 310 enables the user 112 to specify or identify particular target computers 104 by name or other identifier, and to enter the names of these target computers 104 into field 311. For example, the user 112 may name target computers 104 using formats such as fully qualified domain names (FQDN), names given to particular target computers 104 within a domain or other organizational structure, identifiers associated with target computers 104 by the NetBIOS utility, or other equivalent means. Further, the installation wizard 300 can enable the user 112 to identify target computers 104 by manual key-in, voice command, or any other suitable means. The names or other identifiers of the various target computers 104 can be separated by any suitable delimiter.

The installation wizard 300 can also enable the user 112 to identify target computers 104 by supplying a list of computer names or other identifiers from an external source, such as a database or other document, using cut-and-paste techniques.

Also, the user 112 may browse a directory listing of candidate target computers 104 by activating the “Browse” button 312, and may select at least some of the target computers 104 from this directory listing. The installation wizard 300 can also support wildcard-based browsing or searching, as discussed above in connection with defining rules. It is noted that the user 112 may populate the field 311 both by directly entering the names of some target computers 104, and by selecting other target computers 104 from a directory listing.

Once the user 112 has entered data into field 311, the “Next” button 313 is activated, and the user 112 can proceed by activating this button 313 when all desired target computers 104 have been specified in field 311.

Block 315 represents a GUI accessible to the user 112 by activating the area 307 in block 305. In block 315, the user 112 can create new computer discovery rules. If no such rules currently exist, the user 112 can create new ones by activating the “Add” button 316. Existing rules can be edited by activating the “Edit” button 317, or can be removed by activating the “Remove” button 318. When the user 112 has finished adding, modifying, or deleting the rules, the user 112 activates the “Next” button 319 to proceed.

Block 320 represents a GUI accessible to the user 112 by indicating in block 315 that he or she wishes to create a new rule or modify an existing rule. Rules or directives specify how to operate and manage the managed computers 104, and are issued by or on behalf of the operations management system 108. Rules may also identify or specify which agent software 110 is to be deployed to which managed computers 104. For example, a given rule might specify that all target computers 104 having names beginning with the letter “A*” might be subject to some action.

These rules may be executed to discover or locate target computers 104 to which the agent software 110 may be deployed, or from which the agent software 110 may be removed. These rules can employ constructs such as wildcard expanders or equivalent features. In illustrative but non-limiting examples, the user 112 can create rules that match domain names, computer names, ranges of IP addresses, or other equivalent identifiers using at least the following wildcard types:

Begins with

Ends with

Contains

Regular expressions

Boolean regular expressions

Respective fields or areas shown in block 320 enable the user 112 to define or modify rules to implement the above teaching. When the user 112 has completed editing or creating rules, the user 112 can activate the “OK” button 321 to proceed.

A computer discovery rule can be configured with a “verify” property. When the “verify” property is set for a given rule, the central server 102 asynchronously contacts all target computers 104 that match that rule in parallel with the automated deployment process, to ensure that each target computer 104 is available on the network, has a supported operating system version, can receive the agent software, and truly exists on the network before attempting to install the agent software 110. As further precautions, the user 112 and/or the central server 102 can establish a timeout parameter specifying a time limit within which the deployment must complete. Also, the deployment process can provide the user 112 with the option to cancel the batch installation if desired.

Returning to FIG. 2, more particularly block 210 thereof, having identified the target computers 104 onto which the agent software 110 is to be installed, the installation wizard 300 prompts the user 112 for credentials with which to install the agent software 110. In some embodiments, these credentials need only be valid on a given target computer 104, and need not be valid on the central server 102 itself or on other target computers 104. This feature enables the user 112 to deploy the agent software 110 across a variety of domains, forests, or other structures organizing the target computers 104.

These credentials can be provided in several different ways. First, the user 112 at the management console 116 may hold privileges on a given target computer 104 that are sufficient to enable the user 112 authorize automated installation of the agent software 110 thereon. In this case, the user 112 may directly provide his or her credentials. Depending on the context, these rights may be referred to as “administrator rights”, “supervisory rights”, “super user” rights, “root privileges”, or the like.

As another technique for obtaining credentials for deployment, an operations management system 108, such as the MOM system, may support the creation of accounts on the target computers 104 on behalf of the central server 102. The MOM system refers to these accounts as “action accounts”, but other similar accounts having similar characteristics may be recognized as suitable by those skilled in the art. These accounts may be configured with given privilege levels. For example, the MOM system configures these accounts with a “local system” privilege level by default, but these defaults are configurable by the user 112. Credentials associated with these accounts may be stored in the registries of the target computers 104, and accessed by logging-in to the action account. If the privilege levels associated with such accounts on the target computers 104 are sufficient to authorize installing the agent software 110, then credentials associated with these accounts may be provided. In any event, the credentials obtained during the installation may be stored for secure access during subsequent deployment or maintenance of the agent software 110.

Turning to block 215, having established the credentials of the user 112 and/or the central server 102, the installation wizard 300 can then prompt the user 112 to identify a directory on the target computers 104 to which the agent software 110 will be installed. Alternatively, the installation directory may be specified as a default setting, and the installation wizard 300 can enable the user 112 to override the default, if so desired. Known directory browsing techniques and interfaces may be chosen and implemented as appropriate.

Turning to block 220, at this point, the operation of the installation wizard 300 is typically complete. If the user 112 employed the installation wizard 300 to create computer discovery rules, these rules are stored in the database 122 for later retrieval and execution.

B. Computer Discovery Engine and Automatic/Manual Software Management

The computer discovery engine 109 is a component that executes the rules to determine which, if any, target computers 104 in the domain should receive the agent software 110. As such, the computer discovery engine can comprise hardware and/or software components chosen to implement the method as taught herein, and can be realized as part of the central server 102 or as a process callable from the central server 102.

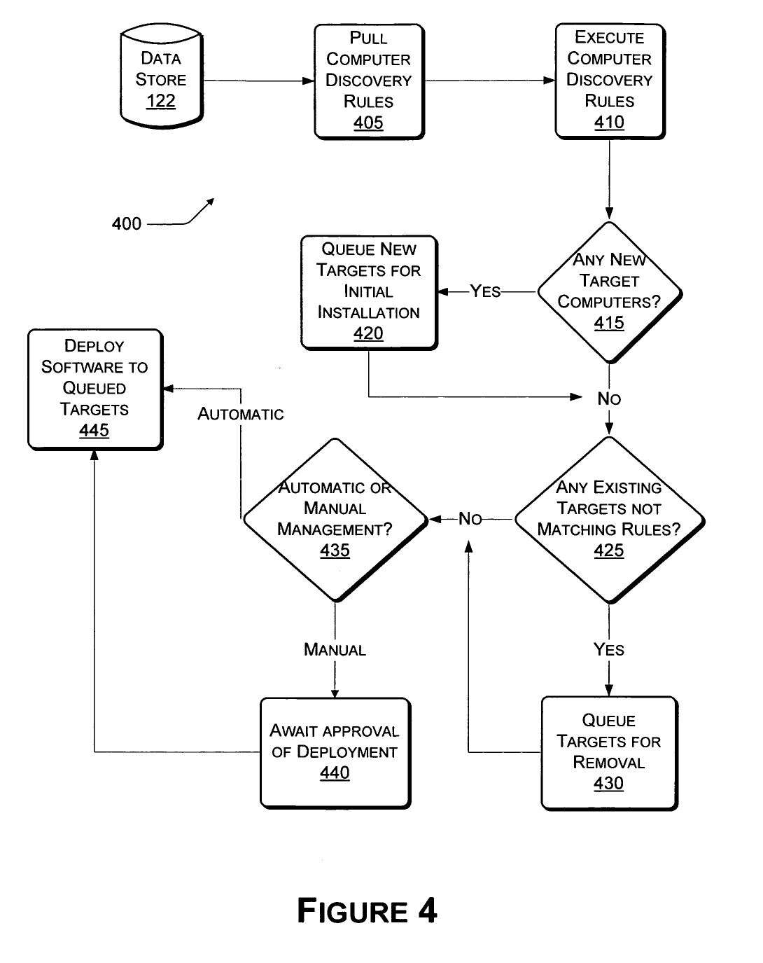

FIG. 4 illustrates a process 400 by which computer discovery rules are executed and the agent software 110 is deployed on target computers 104. Turning to block 405, the computer discovery engine 109 pulls applicable computer discovery rules from the data base 122, and aggregates the rules into a query to run against a domain controller within one or more given domains. In an illustrative but non-limiting example, this query can be run using Lightweight Directory Access Protocol (LDAP), which is well known in the art and not discussed in further detail here. However, other query protocols may also be appropriate. For example, the process 400 can also support, apart from LDAP as mentioned above, querying Net Bios browse lists and/or the WINS database to locate target computers 104. The Windows Internet Name Service (WINS) provides a distributed database for registering and querying dynamic NetBIOS names to IP address mapping in a routed network environment for name resolution. The process 400 can also support resolving computer names to IP addresses when domain information is not provided.

Turning to block 410, the computer discovery engine 109 can be configured to run automatically on a pre-defined periodic schedule (e.g., nightly), or can be initiated by the user 112 when deemed appropriate. Computer discovery also “cooks” down various discovery rules specified for the same domain into ONE query against the domain. Using this capability, the process 400 need query the domain to obtain a list of the target computers 104 only once, irrespective of the number of discovery rules.

Proceeding to block 415, each time the computer discovery engine 109 runs, it evaluates the computer discovery rules to determine whether any new target computers 104 in the domain match the computer discovery rules. If so, the process 400 takes the “Yes” branch from block 415 and queues these target computers 104 for initial installation of a complete version of the agent software 110, as represented by block 420. The process 400 then proceeds to block 425. If no new target computers 104 are in the domain, then the process 400 takes the “No” branch from block 415 to block 425.

At block 425, if any currently-managed computers 106 have the agent software 110 installed, but no longer match any computer discovery rules, then the process 400 takes the “Yes” branch from block 425 and queues these currently-managed computers 106 for removal of the agent software 110, as represented in block 430. The process 400 then proceeds to block 435. If all currently-managed computers 106 still match at least one computer discover rule, the process 400 proceeds to block 435.

When the process 400 has arrived at block 435, the computer discovery engine has completed executing the rules. At block 435, the process 400 determines whether management of agent software 110 on the various target computers 104 is configured to be manual or automatic, as designated by the user 112. If software management is set to an automatic mode, the process 400 takes the “Automatic” branch from block 435 to block 445, where the target computers 104 that are queued for installation or removal of the agent software 110 are run through the deployment process without further intervention by the user 110. If software management is set to a manual mode, the process 400 takes the “Manual” branch from block 435 to block 440, where the target computers 104 are placed in a pending queue to await approval by the user 112 before installation. Also, if any target computers 104 were previously discovered, placed into the pending queue, and have now been approved, then they are now ready to be run through the deployment process, and are queued accordingly. At block 445, the agent software 110 is deployed to the queued target computers 104, as discussed in the next section.

C. Agent Installation Process

Once the queue of target computers 104 awaiting installation is established, installation of the agent software 110 begins asynchronously and in parallel for each target computer 104 in the queue. The use of the term “queue” does not indicate that serial deployments onto the target computers 104 are preferred. Instead, the deployments preferably proceed simultaneously and in parallel, rather than in series. By proceeding simultaneously, delays affecting the deployment on one given target computer 104 will not delay deployment of other target computer 104 behind in the queue.

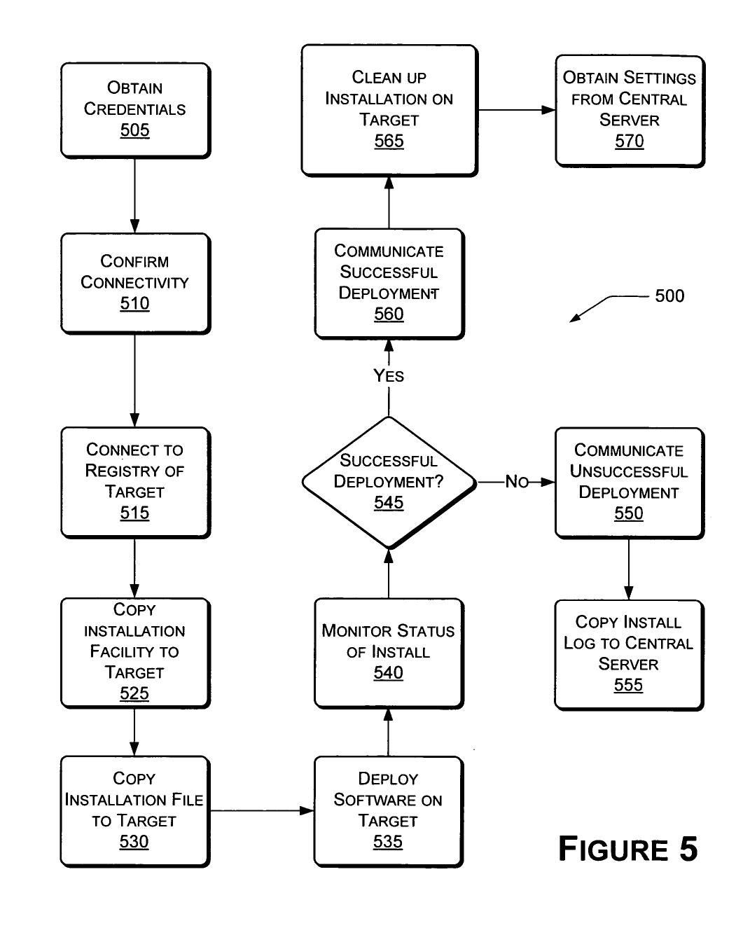

FIG. 5 illustrates a process 500 by which the agent software 110 is installed on various target computers 104. The process 500 proceeds following these illustrative operations.

In block 505, the process 500 obtains credentials and other installation parameters for installing the agent software 110, via a user interface (e.g., from the console 116, the data store 122, or the installation wizard 300 as discussed above) or a suitable application program interface (API). As described above, data representing a domain and username may have been stored for later reference, for example, by the installation wizard 300. Now, the process 500 prompts the user to provide the password for the domain and username.

In block 510, the process 500 interrogates the network 106 coupling the central server 102 to the target computers 104 to determine whether communication channels necessary for the deployment are available.

In block 515, the process 500 remotely connects to the registries (or other equivalent data structures) within the target computers 104, using the credentials obtained as shown in block 505 above. Once connected, the process 500 analyzes the registries of the various target computers 104 to ensure that the environments of the target computers 104 are correct for the deployment, including, but not limited to checking the following pre-requisites:
ensuring that the target computers 104 are running the correct operating systems and any required support services;
determining which particular installation package for the agent software 110 should be installed on the target computers 104;
analyzing chip architecture or other hardware-related compatibility issues relating to the target computers 104;
determining whether the target computers 104 are equipped with the minimum system requirements to support the agent software 110; or
testing communication channel connectivity from the given target computer 104 back to the central server 102; or the like.

The process 500 pre-qualifies the target computers 104 as much as possible before the deployment via an automated process. If any target computers 104 are found deficient, the process reports to the user 112 accordingly.

In block 525, the process 500 remotely creates a temporary installation facility on the target computers 104. The temporary installation facility supports processes that can be called remotely from the central server 102 to perform various functions related to installation. An illustrative but non-limiting facility suitable for this purpose is the DCOM API, provided by Microsoft Corporation.

In block 530, the process 500 copies the installation package file from the central server 102 to a temporary location on the hard disk of the target computers 104. In implementations of the teachings herein, this copy is done as a “push” copy initiated by the central server 102 and not in response to any action taken by the target computer 104. Contrast a “pull” copy initiated by a target computer 104. Also, the installation package file is delivered as a single file, rather than as multiple files.

In block 535, the process 500 calls a method provided by the temporary installation facility (e.g., the DCOM API) to deploy the agent software 110. Also the process 500 passes command line parameters that are used to configure the agent software 110 during deployment.

In block 540, the process 500 monitors the temporary installation facility to determine status of the deployment. If the deployment shows a “success” status, the process continues monitoring in this mode until or unless the status changes to “failure”. If the deployment fails, the process 500 interrogates the temporary installation facility in more detail, along with the application event log, and a utility such as the Windows Management and Instrumentation (WMI) service to determine current status of the deployment, and whether the deployment has succeeded or failed. The process 500 provides continuous status information, including overall success or failure. If a failure occurs, the process 500 indicates a reason for failure in the console 116, and allows the user 112 to investigate the failure, alter any parameters as appropriate, and retry deployment if desired. In some implementations, the process 500 reports status on the deployment to the central server 102 in real time with any failure events that occurred during the deployment.

In block 545, the process 500 determines whether deployment on a given target computer 104 was successful. If so, the process 500 takes the “Yes” branch to block 560, where it communicates a successful deployment to the central server 102. In block 565, the process 500 cleans up the temporary installation facility by deleting it from the target computer 104, along with any other temporary files or directories created as part of the deployment.

In block 570, once the agent software 110 is deployed on the target computers 104, the target computers 104 contact the central server 102 via the communication channel, as referenced in block 510 above, to obtain information specifying how to configure the software settings on the target computer 104. These settings can be transmitted over a secure, encrypted, and authenticated communication channel.

Returning to block 545, if deployment to a given target computer 104 fails, then the process 500 takes the “No” branch to block 550, and reports the unsuccessful deployment to the central server 102. Proceeding to block 555, the process 500 copies an installation log back to the central server 102 for analysis by the user 112.

The process 500 can generate at least two different types of logs and providing them to the user 112, depending on the status of the deployment. An application event log is a summary of events occurring during the deployment, and can be reviewed by the user 112 if he/she wants to perform a cursory review of a given deployment. An installation log provides a more detailed account of any events occurring during the deployment, and can be reviewed to diagnose deployment issues.

It is noted that the process 500 shown in FIG. 5 can also be used to remove agent software 110 from target computers 104 that no longer match any rules, as indicated by decision block 425 in FIG. 4. Such target computers 104 were queued for removal of the agent software 110 in block 430 of FIG. 4. While the process blocks in FIG. 5 refer to “installation” for convenience and conciseness in illustrating and discussing FIG. 5, it is understood that the same process 500 can be used for de-installations of the agent software 110 as well. In this sense, the term “deployment” can include both installing and de-installing the agent software 110.

D. Manual Installation of Agents

In some situations, the user 112 may deploy the agent software 110 manually onto target computers 104 by logging into the target computers 104 and running an installation package. For example, a firewall protecting a given target computer 104 might prevent access to the target computer 104 over a network. However, by using DCOM port binding, for example, it is possible to deploy the agent software 110 through the firewall to the target computer 104, provided that the user 112 has configured the firewall appropriately.

Where the agent software 110 is to be deployed manually, the user 112 may log onto the target computers 104 locally to deploy the agent software 110. The installation package points or directs the agent software 110 to communicate with the central server 102 to obtain configuration information. Alternatively, the agent software 110 can query a directory service provided by the operations management system 108 (e.g., the MOM system) to obtain this directory service is the ACTIVE DIRECTORY™ service offered by Microsoft Corporation. As a security measure, any agent software 110 that is manually deployed onto the target computers 106 can be quarantined until the agent software 110 are approved by the user 112. Until the agent software 110 is approved, it is unable to actively interact or communicate with the operations management system 108 or the central server 102. This feature is a precaution against malicious software that could be installed on managed computers 104 and then executed to launch “denial of service” attacks on the operations management system 108 or the central server 102.

Post-Installation Maintenance of Agent Software

The instant disclosure also includes supporting maintenance of the agent software 110 after it is deployed on the target computers 104. These implementations are now discussed.

A. Upgrading and Patching Agent Software

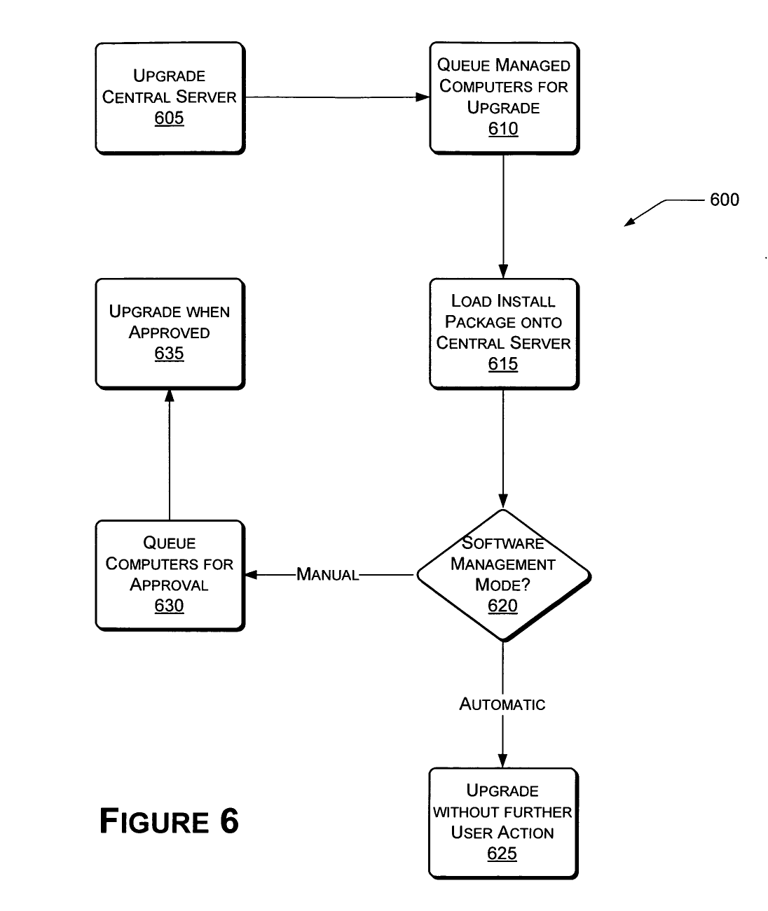

FIG. 6 illustrates a process 600 for upgrading the agent software 110 on the managed computers 106 remotely from the central server 102. In block 605, the software comprising the operations management system 108 on the central server 102 is upgraded. In block 610, the process 600 marks or queues each of the computers 104 managed by that central server 102 for a pending upgrade. In block 615, the process 600 loads a new software installation package in a pre-defined location on the central server 102.

In block 620, the process 600 determines whether management of the agent software 110 is set to an automatic mode or a manual mode. If the agent software 110 is being managed automatically, the process 600 takes the “Automatic” branch to block 625. In block 625, the process 600 installs the upgrade package on the target computers 104 the next time the computer discovery engine runs, without further intervention by the user 112.

Returning to block 620, if the agent software 110 is being managed manually, then the process 600 takes the “Manual” branch to block 630, where the process 600 queues the target computers 104 for approval of the upgrade by the user 112. In block 635, the process 600 upgrades the target computers 104 after approval by the user 112.

Other implementations of the teaching herein can include a “rolling upgrade” of the central server 102 and/or the managed computers 104. In a rolling upgrade, a prior version of the agent software 110 on the managed computers 104 can continue to communicate with a newer or upgraded version of the operations management system 108 on the central server 102, until the agent software 110 on the managed computers 104 is upgraded. Likewise, a prior version of the operations management system 108 on the central server 102 can continue to communicate with a new version of the agent software 110 on the managed computers 104 until the operations management system 108 is upgraded on the central server 102.

FIG. 7 illustrates a process 700 for patching the agent software 110 on the managed computers 106 remotely from the central server 102. Similar to the upgrade process described previously, in block 705, a software patch is applied to a central server 102. In block 710, the process 700 marks or queues each of the computers 104 managed by that central server 102 to receive the patch applied to the central server 102.

In block 715, the process 700 refers to a list of available patches to ensure that all available patches have been installed on all managed computers 104. If this comparison reveals any available patch files that are not installed on a given managed computer 104, then the process 600 takes the “Yes” branch from block 715 to block 720, where the process 700 adds these any missing patches to the installation file to be installed during the next deployment action. Returning to block 715, if a given managed computer 104 is up-to-date and is not missing any patches, the process 700 takes the “No” branch and goes directly to block 725. In block 725, the process 700 loads a new file containing the software patch or patches in a pre-defined location on the central server 102.

In block 730, the process 700 determines whether management of the agent software 110 is set to an automatic mode or a manual mode. If the agent software 110 is being managed automatically, the process 700 takes the “Automatic” branch to block 735. In block 735, the process 700 installs the patch package on the target computers 104 the next time the computer discovery engine runs, without further intervention by the user 112. It is noted that the patch package can be automatically installed by running computer discovery, or by using a menu option from the UI to apply the patch package.

Returning to block 730, if the agent software 110 is being managed manually, then the process 700 takes the “Manual” branch to block 740, where the process 700 queues the managed computers 104 for approval of the patch(es) by the user 112. In block 745, the process 700 patches the target computers 104 after approval by the user 112.

Regarding blocks 735 and 745, whether the agent software 110 is being managed automatically or has been manually approved to receive the patch(es), if a given managed computer 104 is missing any previously-available patches, it receives these missing patches, in addition to the patch applied to the central server 102 as represented in block 705 above.

B. Updating Software Settings

Some implementations of the instant teachings can include updating software settings or other types of configuration settings on the managed computers 104 remotely from the central server 102. In some instances, the configuration settings of given managed computers 104 can become unsynchronized with the central server 102. In most cases, such discrepancies can be resolved via the channel through which the central server 102 and the managed computers 104 normally communicate. However, some discrepancies cannot be resolved through the normal communication channel. For example, some security-related settings, such as mutual authentication, are difficult to perform solely via the communications channel. Another example involves changing parameters relating to the communication channel itself, such as changing a port number assigned to the channel. In such a case, changing the port number of the channel effectively breaks the channel itself, precluding further communication on that channel.

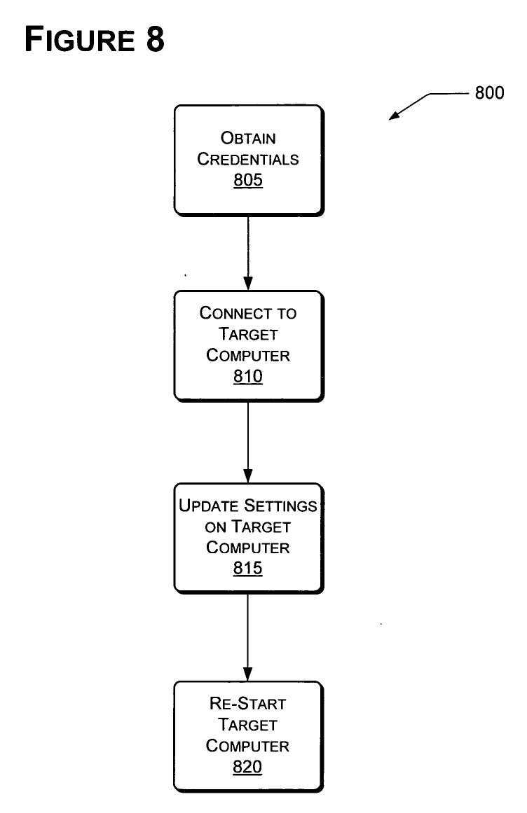

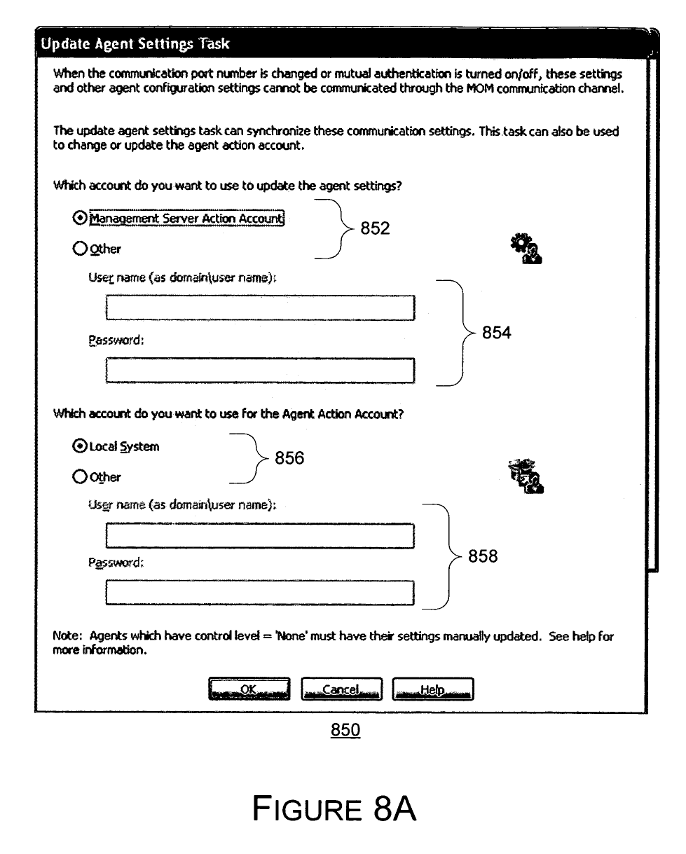

FIG. 8 illustrates a process 800 that addresses the above issues by enabling the user 112 to initiate a synchronization process using, for example, a wizard. In block 805, the process 800 can prompt the user 112 as necessary to obtain appropriate credentials with administrator privileges on the target computer 104. In block 810, the process 800 remotely connects the target computer 104 to the central server 102. In block 815, the process 800 updates configuration settings on the target computer 104 to re-synchronize with the central server 102. In block 820, the process 800 restarts the target computer 104, and/or the agent software 110 running thereon, so the new configuration settings take effect. After the target computer 104 and/or the agent software 110 have restarted, the new configuration settings take effect (e.g., authentication, new communications port, etc.).

FIG. 8A illustrates a graphical user interface (GUI) 850 that may be presented to the user 112 in connection with the process 800 shown in FIG. 8. The GUI 850 enables the user 112 to configure parameters relating to the process 800. Turning to field 852, the user 112 can select whether to use credentials associated with the Management Server Action Account to perform the re-synchronization by selecting the appropriate toggle. If the user 112 wishes to supply his or her credentials for the re-synchronization, the user 112 can select the “Other” field and provide a user name and password combination in field 854.

Turning to field 856, the user 112 can specify which account to use for the Agent Action Account by either selecting “Local System”, or by selecting “Other” and providing a user name and password combination in field 858. In either event, when the user 112 has completed configuring the parameters for the process 800, the user 112 activates the “OK” button.

C. Repairing Software on Target Computers

From the central server 102, the user 112 can repair agent software 110 running on given target computers 104 using, for example, a process similar to the process 800 shown in FIG. 8, the user 112 supplies administrator credentials valid on the given target computers 104. The central server 102 then connects to the target computers 104 and installs an appropriate package (e.g., a standard WINDOWS® installation/repair package) to replace binary files and to update registry settings as necessary to repair the agent software 110. The target computer 104 and/or the agent software 110 is then restarted to run the newly-repaired agent software 110.

D. Self-Updating Software Running on Target Computers

The central server 102 can enable manual downloads of patches and upgrades to the agent software 110 running on target computer 104. Alternatively, the central server 102 can cooperate with a product such as the Systems Management Server (SMS) offered by Microsoft Corporation. Further, the central server 102 may cooperate with a software update utility (such as the Microsoft UPDATE utility) or another public source of software upgrades to automate downloads of the patches and upgrades to the agent software 110. Similar to the process 800 shown in FIG. 8, files containing the patches and upgrades can be stored on the central server 102 in a pre-defined location. These patches/upgrades can then be automatically deployed to the target computers 104 without further intervention by the user 112 when the computer discovery engine next executes, if software management is set to an automatic mode. Alternatively, these patches/upgrades can be queued for approval by the user 112, if software management is set to manual mode, as discussed previously.

E. Self-Healing Software Running on Target Computers

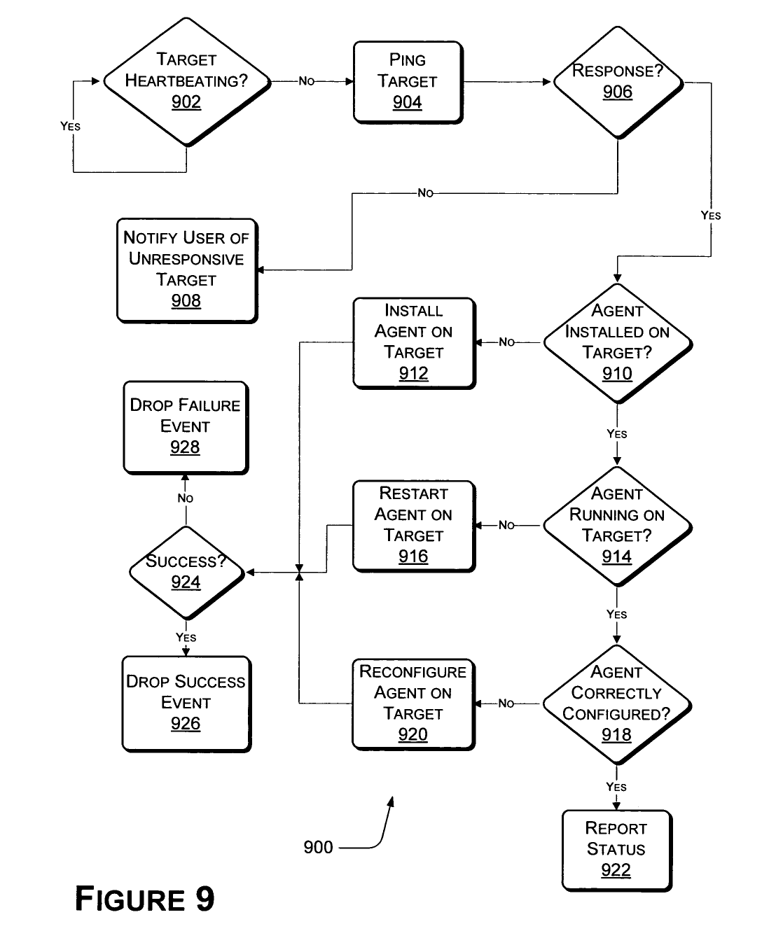

FIG. 9 illustrates a process 900 by which the agent software 110 that is deployed on the various managed computers 104 can be monitored and repaired remotely by the operations management system 108 executing on the central server 102. By providing the agent software 110 on the target managed computers 104 with a heartbeating mechanism, process 900 can enable the agent software 110 executing on the managed computers 104 to “self-heal”, should issues arise with a given managed computer 104.

Turning to block 902, the heartbeating mechanism can be implemented in any number of ways, including, for example, having the given managed computers 104 periodically transmit a pre-defined message to the central server 102. The process 900, executing on, for example, the central server 102, can then traverse a listing of the managed computers 104 and identify any that have not sent this message within the defined interval. Alternatively, the process 900, executing on, for example, the managed computers 104, could affirmatively send a message when a failure occurs on a given managed computer 104.

APIs to perform this self-healing function can be exposed publicly and can be configured to run on a predefined schedule. Also, the central server 102 can be configured to periodically query the database 122 to determine which managed computers 104 have agent software 110 installed, but are not currently heartbeating. For any such managed computers 104, the central server 102 can initiate the self-healing diagnostic, and can run any suitable repair actions against these managed computers 104.

In any event, when the agent software 110 on a given managed computer 104 fails to heartbeat over the predefined interval, this may indicate a failure on the given managed computer 104. In block 904, the process 900, executing on, for example, the central server 102, can investigate the failure by automatically running diagnostic tasks, such as an Internet Control Message Protocol (ICMP) ping, and analyzing the results thereof. Sometimes, a given managed computer 104 may be busy with other tasks and cannot heartbeat within the required time interval, but can respond to a ping sent by the central server 102.

In block 906, the process 900 determines whether the managed computer 104 responded to the ping sent in block 904. If the managed computer 104 did not respond, the process 900 takes the “No” branch to block 620, where the process 900 notifies the user 112 that the managed computer 104 is unresponsive. The user 112 can then investigate the given managed computer 104 further.

Returning to block 906, if the managed computer 104 responds in some way to the ping, the process 900 takes the “Yes” branch to block 910, where the process 900 can then take various corrective actions based on the results of the diagnostic tasks associated with the ping. Illustrative corrective actions and related testing are now discussed. In block 910, the process 900 determines whether the agent software 110 is installed on the managed computer 104. If the agent software 110 is not installed on the managed computer 104, the process 900 takes the “No” branch to block 912, where the agent software 110 is re-installed using the above deployment process.

Returning to block 910, if the agent software 110 is installed on the managed computer 104, the process 900 takes the “Yes” branch to block 914, where the process 900 determines whether the agent software 110 is running on the given managed computer 104. If the agent software 110 is not running on the given managed computer 104, the process 900 takes the “No” branch to block 916. Due to any number of factors, agent software 110 may be installed on a given managed computer 104, but may not be executing at a given time. For example, the agent software 110 may be hung in a loop, “frozen”, or mistakenly disabled by the user 112 or someone else. In such a case, in block 916, the process 900 remotely restarts the managed computer 104 and/or the agent software 110.

Returning to block 914, if the agent software 110 is installed and running on the given managed computer 104, the process 900 takes the “Yes” branch to block 918, where the process 900 determines whether the agent software 110 is configured correctly. If the agent software 110 is not configured correctly, the process 900 takes the “No” branch to block 920, where the process 900 updates the configuration of the given managed computer 104 or repairs the agent software 110, using, for example, the techniques discussed above.

Returning to block 918, if the process 900 reaches block 922, it alerts the user 112 accordingly for follow up. Alternatively, the process 900 can delete block 918, and conclude that if the output from block 914 is “Yes”, then the given managed computer 104 must be incorrectly configured and proceed directly to block 920. Thus, the implementation shown in FIG. 9 illustrates the process 900 including a final decision block 918 that may be deleted.

Turning to block 924, the process 900 reaches this block after completing either of blocks 912, 916, or 920. If the process 900 as represented by either of blocks 912, 916, or 920 was successful, the process 900 takes the “Yes” branch to block 926, where the process 900 drops a success event. Returning to block 924, if the process 900 as represented by either of blocks 912, 916, or 920 was unsuccessful, the process takes the “No” branch to block 928, where the process 900 drops a failure event.

After completing either block 926 or 928, the process 900 returns to block 902, where the process 900 determines whether the remedial actions taken in blocks 912, 916, and/or 920 restored the heartbeat function expected of the given managed computer 104. If so, the process 900 takes the “Yes” branch and loops in place at block 902 until the heartbeat fails, at which time the process 900 proceeds to block 904 as discussed above. Returning to block 902, if the remedial actions taken in blocks 912, 916, and/or 920 did not restore the expected heartbeat function, the process 900 proceeds immediately to block 904 for another iteration through FIG. 9 to address further problems with the given managed computer 104.

FIG. 10 illustrates an exemplary computing environment 1000 within which the systems and methods described herein, as well as the computing, network, and system architectures described herein, can be either fully or partially implemented. For example, the central server 102 and/or the managed computers 104 can be implemented, in whole or in part, using the exemplary computing environment 1000. However, it is noted that exemplary computing environment 1000 is only one example of a computing system and is not intended to suggest any limitation as to the scope of use or functionality of the architectures. Neither should the computing environment 1000 be interpreted as having any dependency or requirement relating to any one or combination of components illustrated in the exemplary computing environment 1000.

The computer and network architectures in computing environment 1000 can be implemented with numerous other general purpose or special purpose computing system environments or configurations. Examples of well known computing systems, environments, and/or configurations that may be suitable for use include, but are not limited to, personal computers, server computers, client devices, hand-held or laptop devices, microprocessor-based systems, multiprocessor systems, set top boxes, programmable consumer electronics, network PCs, minicomputers, mainframe computers, gaming consoles, distributed computing environments that include any of the above systems or devices, and the like.

The computing environment 1000 includes a general-purpose computing system in the form of a computing device 1002. The components of computing device 1002 can include, but are not limited to, one or more processors 1004 (e.g., any of microprocessors, controllers, and the like), a system memory 1006, and a system bus 1008 that couples the various system components. The one or more processors 1004 process various computer executable instructions to control the operation of computing device 1002 and to communicate with other electronic and computing devices. The system bus 1008 represents any number of several types of bus structures, including a memory bus or memory controller, a peripheral bus, an accelerated graphics port, and a processor or local bus using any of a variety of bus architectures.

Computing environment 1000 includes a variety of computer readable media which can be any media that is accessible by computing device 1002 and includes both volatile and non-volatile media, removable and non-removable media. The system memory 1006 includes computer readable media in the form of volatile memory, such as random access memory (RAM) 1010, and/or non-volatile memory, such as read only memory (ROM) 1012. A basic input/output system (BIOS) 1014 maintains the basic routines that facilitate information transfer between components within computing device 1002, such as during start-up, and is stored in ROM 1012. RAM 1010 typically contains data and/or program modules that are immediately accessible to and/or presently operated on by one or more of the processors 1004.

Computing device 1002 may include other removable/non-removable, volatile/non-volatile computer storage media. By way of example, a hard disk drive 1016 reads from and writes to a non-removable, non-volatile magnetic media (not shown), a magnetic disk drive 1018 reads from and writes to a removable, non-volatile magnetic disk 1020 (e.g., a “floppy disk”), and an optical disk drive 1022 reads from and/or writes to a removable, non-volatile optical disk 1024 such as a CD-ROM, digital versatile disk (DVD), or any other type of optical media. In this example, the hard disk drive 1016, magnetic disk drive 1018, and optical disk drive 1022 are each connected to the system bus 1008 by one or more data media interfaces 1026. The disk drives and associated computer readable media provide non-volatile storage of computer readable instructions, data structures, program modules, and other data for computing device 1002.

Any number of program modules can be stored on RAM 1010, ROM 1012, hard disk 1016, magnetic disk 1020, and/or optical disk 1024, including by way of example, an operating system 1028, one or more application programs 1030, other program modules 1032, and program data 1034. Each of such operating system 1028, application program(s) 1030, other program modules 1032, program data 1034, or any combination thereof, may include one or more embodiments of the systems and methods described herein.

Computing device 1002 can include a variety of computer readable media identified as communication media. Communication media typically embodies computer readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example and not limitation, communication media includes wired media such as a wired network or direct-wired connection, and wireless media such as acoustic, RF, infrared, other wireless media, and/or any combination thereof.

A user 112 can interface with computing device 1002 via any number of different input devices such as a keyboard 1036 and a pointing device 1038 (e.g., a “mouse”). Other input devices 1040 (not shown specifically) may include a microphone, joystick, game pad, controller, satellite dish, serial port, scanner, and/or the like. These and other input devices are connected to the processors 1004 via input/output interfaces 1042 that are coupled to the system bus 1008, but may be connected by other interface and bus structures, such as a parallel port, game port, and/or a universal serial bus (USB).

A display device 1044 (or other type of monitor) can be connected to the system bus 1008 via an interface, such as a video adapter 1046. In addition to the display device 1044, other output peripheral devices can include components such as speakers (not shown) and a printer 1048 which can be connected to computing device 1002 via the input/output interfaces 1042.

Computing device 1002 can operate in a networked environment using logical connections to one or more remote computers, such as remote computing device 1050. By way of example, remote computing device 1050 can be a personal computer, portable computer, a server, a router, a network computer, a peer device or other common network node, and the like. The remote computing device 1050 is illustrated as a portable computer that can include any number and combination of the different components, elements, and features described herein relative to computing device 1002.

Logical connections between computing device 1002 and the remote computing device 1050 are depicted as a local area network (LAN) 1052 and a general wide area network (WAN) 1054. Such networking environments are commonplace in offices, enterprise-wide computer networks, intranets, and the Internet. When implemented in a LAN networking environment, the computing device 1002 is connected to a local network 1052 via a network interface or adapter 1056. When implemented in a WAN networking environment, the computing device 1002 typically includes a modem 1058 or other means for establishing communications over the wide area network 1054. The modem 1058 can be internal or external to computing device 1002, and can be connected to the system bus 1008 via the input/output interfaces 1042 or other appropriate mechanisms. The illustrated network connections are merely exemplary and other means of establishing communication link(s) between the computing devices 1002 and 1050 can be utilized.

In a networked environment, such as that illustrated with computing environment 1000, program modules depicted relative to the computing device 1002, or portions thereof, may be stored in a remote memory storage device. By way of example, remote application programs 1060 are maintained with a memory device of remote computing device 1050. For purposes of illustration, application programs and other executable program components, such as operating system 1028, are illustrated herein as discrete blocks, although it is recognized that such programs and components reside at various times in different storage components of the computing device 1002, and are executed by the one or more processors 1004 of the computing device 1002.

Those skilled in the art will recognize that the layout of the components shown in the drawings figures throughout this description is illustrative rather than limiting, and that these various components could be geographically dispersed or concentrated as appropriate in various implementations of the teaching herein. For example, the data flows shown in FIG. 1 and throughout this description are chosen for convenience in illustration and discussion, and these data flows can be altered, combined, integrated, segregated, or otherwise modified from those illustrated herein without departing from the scope of the teachings herein. For example, for clarity and readability, FIG. 1 illustrates two managed computers 104. However, the teachings herein can be practiced with any number of managed computers 104. In general, the number of entities or other components shown and discussed herein, as well as the order of process steps, are not limiting unless expressly stated so herein.

Various embodiments of the teachings herein are described above to facilitate a through understanding of various aspects of the teachings herein. However, these embodiments are to be understood as illustrative rather than limiting in nature, and those skilled in the art will recognize that various modifications or extensions of these embodiments are possible.

What is claimed is:

1. In an operations management system comprising a central server managing a plurality of computer systems, an automated method performed by the central server to deploy agent software to the plurality of managed computer systems, the automated method comprising:
enabling a user to select target computer systems to which to deploy the agent software;
pre-qualifying the target computer systems to identify issues that may impact the deployment of the agent software to the target computer systems;
ensuring network connectivity from the target computer systems back to the central server during the deployment; and
asynchronously push-deploying the agent software in parallel to each of the target computer systems.

2. The method of claim 1, wherein enabling the user to select the target computer systems includes enabling the user to perform at least one of the following:
create a plurality of rules supporting automated discovery of the target computer systems;
specify a list of the target computer systems using manual or verbal means;
browse a directory listing of candidate target computers; or
insert names of the target computers from an external source.

3. The method of claim 1, wherein enabling the user to select the target computers includes presenting the user with an interactive user interface that enables the user to specify a plurality of rules supporting automated discovery of the target computer systems.

4. The method of claim 3, further comprising associating a verify property with at least one of the rules, wherein, in response to the verify property being set for a given rule, the central server asynchronously contacts at least one of the target computers corresponding to the given rule in parallel with a deployment process.

5. The method of claim 3, further comprising enabling the user to specify that all target computer systems located by any of the rules be installed with the agent software without any further intervention by any user.

6. The method of claim 3, further comprising enabling the user to specify that all target computer systems located by any of the rules be installed with the agent software only after approval by the user.

7. The method of claim 3, further comprising aggregating the rules into a query to run against a list of the managed computers as provided by a domain controller, wherein the query generates a list of the target computer systems.

8. The method of claim 7, further comprising executing the rules automatically on a predefined periodic basis, and further comprising executing the rules at least once at the discretion of the user.

9. The method of claim 1, further comprising creating a queue of target computer systems that match selection criteria specified by the user.

10. The method of claim 1, further comprising deploying the agent software to each of the target computer systems in a queue.

11. The method of claim 1, wherein pre-qualifying the target computer systems is performed before push-deploying the agent software to the target computer systems.

12. The method of claim 11, further comprising notifying the user of compatibility problems affecting specific target computer systems before push-deploying the agent software to the specific target computer systems.

13. The method of claim 1, further comprising obtaining credentials necessary for deploying the agent software, wherein the credentials are valid on particular, respective ones of the target computer systems.

14. The method of claim 1, wherein simultaneously and asynchronously push-deploying the agent software includes push-deploying the agent software only in response to the central server and not in response to any action performed by the target computer systems.

15. The method of claim 1, further comprising configuring the agent software on the target computers based on specifications stored on the central server.

16. The method of claim 1, further comprising manually deploying the agent software on at least a further one of the target computer systems.

17. The method of claim 16, further comprising opening a communication channel from the further one of the target computer systems to the central server.

18. The method of claim 16, further comprising quarantining the agent software that is manually deployed on the further one of the target computer systems, and wherein the agent software that is manually deployed remains quarantined pending manual approval of the deployment by the user.

19. One or more computer readable media comprising computer executable instructions that, when executed, direct a computing device to:
enable a user to select a plurality of target computer systems to which to deploy the agent software;
pre-qualify the target computer systems to identify issues that may impact the deployment of the agent software to the target computer systems;
ensure network connectivity from the target computer systems back to the central server; and
asynchronously push-deploy the agent software in parallel to the each of the plurality of target computer systems.

20. A device, comprising:
means for enabling a user to select a plurality of target computer systems to which to deploy the agent software;
means for pre-qualifying the target computer systems to identify issues that may impact the deployment of the agent software to the target computer systems;
means for ensuring network connectivity from the target computer systems back to the central server; and
means for asynchronously push-deploying the agent software in parallel to the each of the plurality of target computer systems.
